(19) United States
(12) Patent Application Publication
(10) Pub. No.: US 2013/0047379 A1
(43) Pub. Date: Feb. 28, 2013

(54) GRIP ENHANCEMENT DEVICE

(71) Applicant: Darrin Zilke, Lyle, WA (US)

(72) Inventor: Darrin Zilke, Lyle, WA (US)

(73) Assignee: The True Grip, Inc., Beaverton, OR (US)

(21) Appl. No.: 13/217,015

(22) Filed: Aug. 24, 2011

(51) Int. Cl. B25G 1/10; B23P 11/00

(52) U.S. Cl. 16/421; 29/428

(57) ABSTRACT

A grip enhancement device for improving a user's grip on a handgun, bow, tennis racket, golf club, or other object which is gripped in the hand, and a method for its use.

### BACKGROUND OF THE INVENTION

Many hand-held objects offer optimum performance when gripped properly, and in particular performance is enhanced by consistency of grip. Examples include tennis rackets, golf clubs, bows, and most especially handguns. A police officer who uses a handgun as a primary lethal force option will often have only a fraction of a second's notice that an otherwise routine encounter is about to become a gunfight. Yet proper accuracy and firearm function are only achieved with a steady and consistent grip. The risk of slippage has been mitigated in the prior art by the use of checkering, stippling, and finger ridges. For instance, U.S. Pat. D351,448 discloses finger ridges intended to be attached to a handgun. Of the prior art choices, only finger ridges assist in placing the hand in the proper position relative to the trigger and action. Prior art ridges, however, lack a means to control how a pistol's grip twists in an officer's hands, meaning that in the haste to present the firearm, the officer may wind up with a gun pointed off at an angle from what is expected. This is especially true with modern double-stack pistols, which have grips that are closer to square rather than oblong or rectangular, and thus do not “point” as naturally. A twisted grip will lead to missed shots or wasted time as the grip is adjusted.

While conventional military units use rifles as a primary weapon and carry handguns only as a backup, those engaged in certain duties (such as military police) as well as special forces units, may find that they also require a handgun that may be deployed as quickly as possible consistent with accuracy.

Target shooters have improved the consistency of their grip by creating bulky contrivances that adjust in every imaginable way. Some include straps or hard protrusions through which a shooter's hand is inserted, making the grip more like a glove. Some shooters have even gone so far as to take castings of their hands so that grips may be molded to match that particular hand as perfectly as possible. Such extremes are impractical for police or military use because they are too bulky for everyday carry, expensive when considered for large numbers of guns, impractical to attach to popular handguns chambered in self-defense calibers, and not conductive to a rapid draw.

A hunter shooting a bow does not need to acquire a grip as quickly as would a police officer faced with an armed criminal. However, a bowhunter's grip is still critical to accuracy, because the shooting of an arrow is an event which is both dynamic, in that it involves the interplay of many variables that cannot be consciously controlled during the moment of the shot, and slow enough that the interaction of bow and arm before an arrow's release can mean that different grips will result in different points of impact. Additionally, a bowhunter must achieve a consistent grip with a minimum of movement to avoid spooking game. Prior art bows have made strides toward addressing these concerns, but unless they are custom-made at great expense, they remain an “average” solution which must fit many archers imperfectly.

What is needed, then, is a means of customizing a grip that is inexpensive, lightweight, and easily attached to popular fighting handguns and bows. This device could also be adapted to any use where consistency of grip is desirable.

### BRIEF SUMMARY OF THE INVENTION

The problems of the prior art are solved by providing an elastic loop sized to be slipped over the grip portion of an object and held there by friction. The loop has ridges running circumferentially that are positioned to form a groove for guiding the finger of a user into position. In addition, the loop has a shelf which can be placed at the point where a fingertip of a user is placed when the proper grip has been attained. In this way the grip enhancement device positions the hand in both the axial and circumferential direction, and provides tactile feedback helping a user to learn the proper grip and achieve it consistently under stress or time pressure.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a perspective view of one embodiment of the invention mounted on a GLOCK® handgun.

FIG. 2 is a perspective view of one embodiment of the invention showing the interaction with a user's hand.

FIG. 3 is a perspective view of one embodiment of the invention.

FIG. 4 s a section along the line 4-4 in FIG. 3

FIG. 5 is a depiction of one embodiment of the invention mounted on a rifle.

FIG. 6 is a depiction of one embodiment of the invention mounted on a tennis racket.

FIG. 7 is a depiction of one embodiment of the invention mounted on a bow.

FIG. 8 is a depiction of one embodiment of the invention mounted on a golf club.

### DETAILED DESCRIPTION OF PREFERRED EMBODIMENT

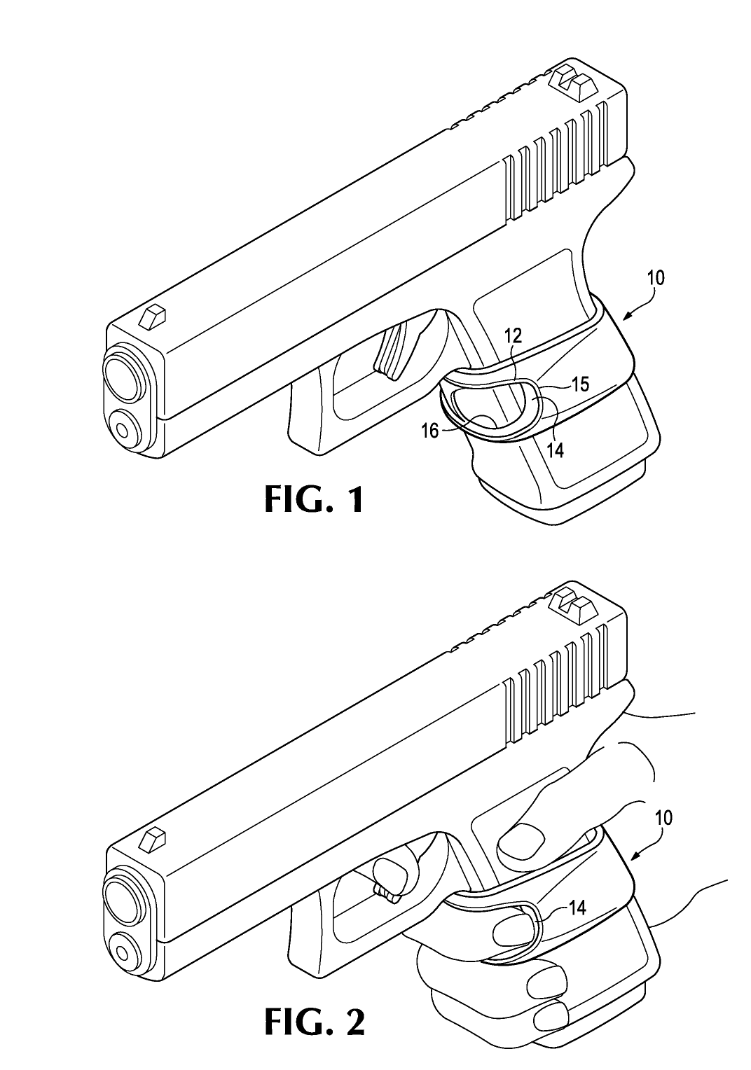

Referring now to the drawings, FIG. 1 shows one embodiment of a grip enhancement device 10 mounted on the grip of a GLOCK® handgun. This is a popular police handgun whose plastic frame is not easily customized. The invention is not limited to use on any specific brand of handgun, or on handguns exclusively. The grip enhancement device 10 may be composed of soft elastomeric compound such as rubber or other polymer, formed into a loop that fits snugly over the grip. The surface and relative tightness of the grip enhancement device 10 should be chosen so as to make movement difficult. That is, the surface finish should have a relatively high coefficient of friction and the fit should be relatively tight. This reduces the chances of shifting and the associated change in grip position. An adhesive may also be used for this purpose. Preferably, the loop is thin enough over most of its area that its presence does not noticeably affect the feel of the object to which it is attached. However, it is possible to alter the thickness of the material for particular purposes. For instance, the loop material could be made thicker than usual to improve the comfort of a grip for users with large hands, or to offer cushioning against recoil forces.

The materials available for use in constructing a grip enhancement device 10 are well known in the art. Any material selected must be impervious to common solvents, resistant to heat, UV exposure, and atmospheric oxygen. For this reason synthetic polymers are preferred.

Ridges 12 are integrally formed into the loop perpendicular to the loop's axis, and are intended to be positioned on the front strap of a handgun's grip. For use on other objects, such as tennis rackets or golf clubs, the ridges 12 may be placed in the desired position for a user's finger. These ridges 12 then form a channel in which a user's finger is placed. The ridges 12 tend to position the finger vertically and to resist vertical movement such as might be encountered when a handgun recoils. In this way they both ensure a consistent, properly positioned grip and help maintain that grip during use. The depicted grip enhancement device 10 has only two ridges 12, positioned near the edges of the device, to accommodate a single finger. In a preferred embodiment, this is the middle finger, which is large and relatively strong, and therefore can be used to position the remainder of the hand. Additional ridges 12 could be formed to guide more than one finger into position. This results in a more secure grip, but sacrifices a degree of fit because different users may have fingers of different thicknesses, which by their nature cannot be accommodated in a one-size-fits-all device. This problem can be mitigated by offering the grip enhancement device 10 in multiple sizes.

Shelf 14 is formed integrally at one end of the ridges 12 and presents a surface roughly parallel to the axis of the loop that extends radially outward from the surface of the loop. This shelf 14 is adjusted on the object so that a finger tip of the finger placed between the ridges 12 will be against it when the user's hand is in the optimal position. In this way, a user who is forming a grip under stress, such as a police officer drawing a handgun in response to a threat, will have immediate tactile feedback indicating whether or not the proper grip has been obtained. In this way the user's grip is rendered both optimal and consistent.

In addition, behind the shelf 14 a nub 15 is formed, which may offer a place to rest the user's thumb. The nub 15 will not always be reachable by the user, depending on the relative sizes of the object to be gripped and the user's hand, but in cases where it is, it offers yet another way for the hand to be guided into position even at high speed.

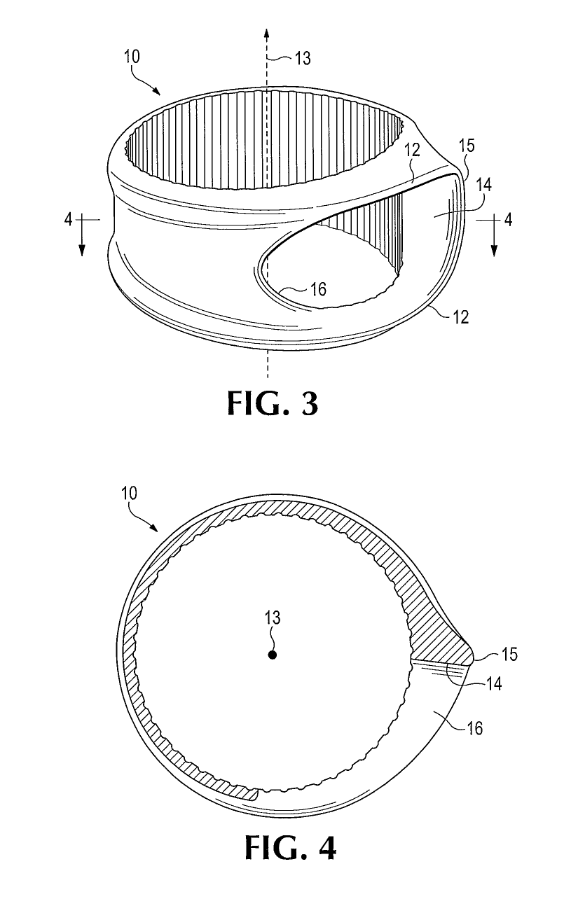

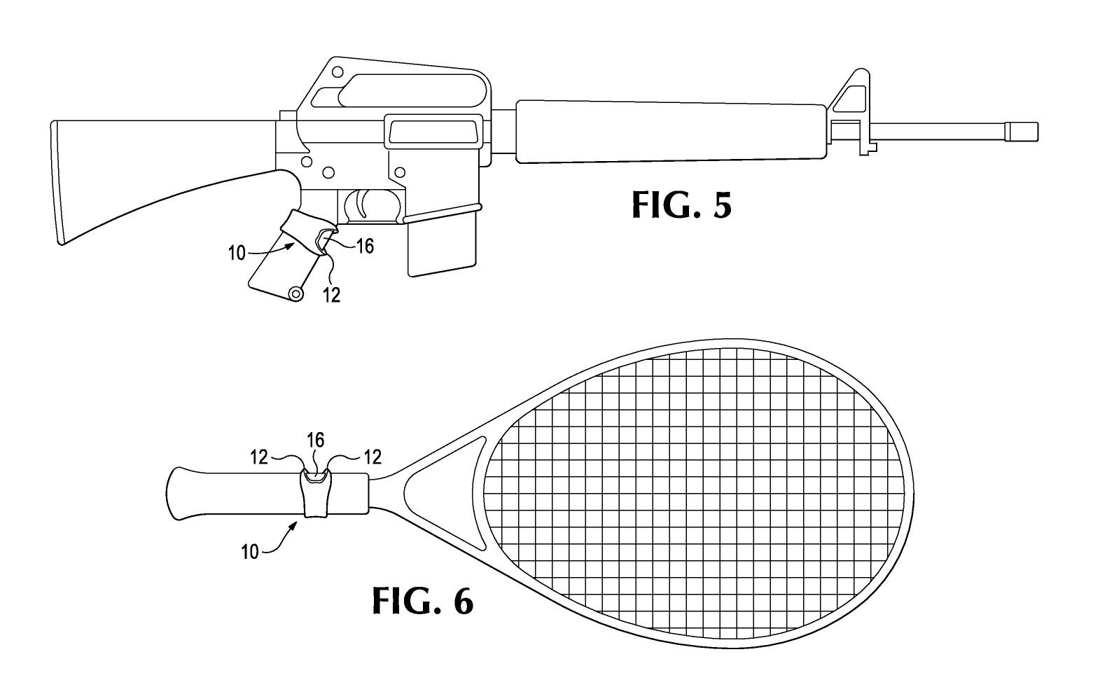

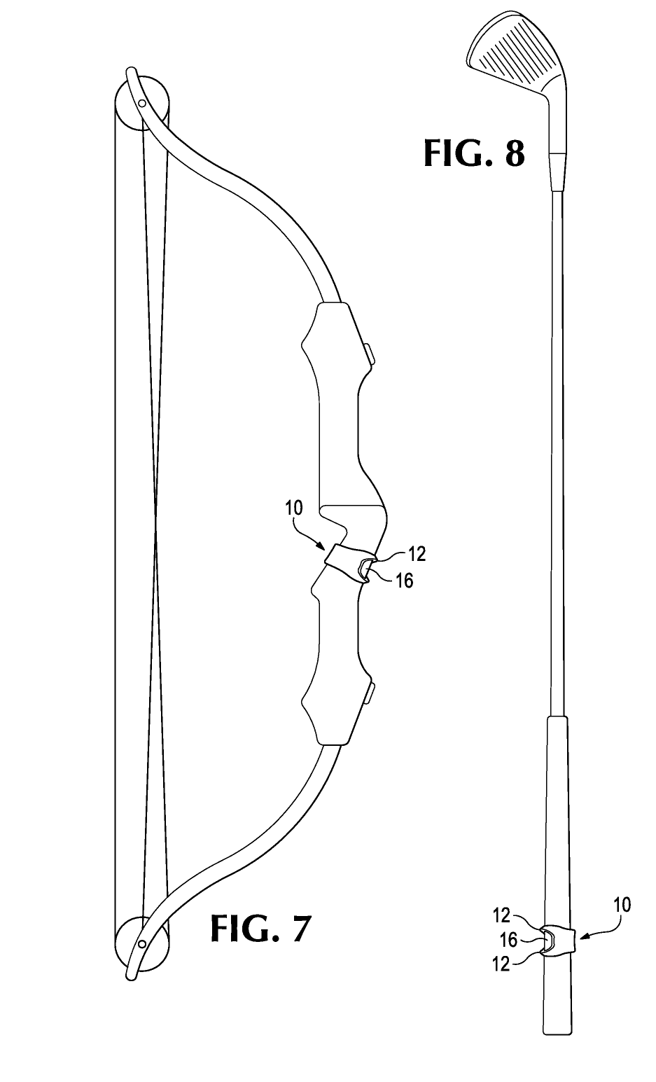

Preferably, the grip enhancement device 10 is substantially symmetrical when cut along a plane perpendicular to its axis, such as line 4-4 in FIG. 3. This symmetry permits the grip enhancement device 10 to be installed by both left and right-handed users in the fashion that is most advantageous to them.

Preferably, the grip enhancement device 10 has a hole 16 between the ridges 12. This hole 16 both minimizes the overall increase in grip size cause by the addition of the grip enhancement device 10, and permits the placement of buttons, switches, or other items which may be manipulated by a user in the hole 16 area. Many popular handguns have rails to accommodate lights or laser sights, which are then turned on or off by switches on the handgun's grip. The presence of the hole 16 maintains the functionality of these items by allowing access to their controls. Note that the hole 16 may be located in places other than between the ridges 12, if the button, switch, or manipulatable item is located somewhere else. The hole 16 may also be omitted to increase the durability or service life of the grip enhancement device 10 where no switches or buttons are in use.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A grip enhancement device, comprising:
a. an elastic loop having an axis;
b. a plurality of ridges disposed perpendicular to said axis; and
c. exactly one shelf disposed substantially parallel to said axis.

2. The device of claim 1 further comprising a hole in said loop, at least part of which is located between two of said ridges.

3. The device of claim 1 wherein the shelf is disposed between said ridges.

4. The device of claim 1 having exactly two of said ridges.

5. (canceled)

6. A method of improving a user's grip on an object, comprising the steps of:
a. providing a grip enhancement device comprising an elastic loop having an axis, a plurality of ridges disposed perpendicular to said axis and a shelf disposed substantially parallel to said axis, and loop being so sized as to fit snugly on a portion of the object to be gripped;
b. placing the grip enhancement device on the object; and
c. adjusting the position of the grip enhancement device such that the ridges will be located on either side of a desired position for a user's finger and the shelf will be located at the desired position for a user's fingertip when the object is in use.

7. The method of claim 6 wherein said grip enhancement device has exactly two of said ridges.

8. The method of claim 7 wherein said ridges are located on either side of the desired position of a user's middle finger.

9. (canceled)

10. The method of claim 6 wherein said grip enhancement device has a hole passing through said loop, and wherein said device is so adjusted that said hole gives access to an item on said object that may be manipulated.
